(19) United States
(12) Patent Application Publication
(10) Pub. No.: US 2026/0269095 A1
(43) Pub. Date: Sep. 10, 2026

(54) BUBBLE-ENHANCED NATURAL CONVECTION REACTOR FLOW

(71) Applicant: Natura Resources LLC, Abilene, TX (US)

(72) Inventors: Kevin Clarno, Abilene, TX (US); Steven Biegalski, Abilene, TX (US); Mark Kimber, Abilene, TX (US); Derek Haas, Abilene, TX (US); Pavel Tsvetkov, Abilene, TX (US)

(21) Appl. No.: 19/557,331

(22) Filed: Mar. 5, 2026

Related U.S. Application Data
(60) Provisional application No. 63/767,330, filed on Mar. 5, 2025.

(51) Int. Cl. G21C 19/28; G21C 1/32; G21C 3/54; G21C 9/02; G21C 19/08

(52) U.S. Cl. CPC G21C 19/28; G21C 1/322; G21C 3/54; G21C 9/02; G21C 19/08

(57) ABSTRACT

An integral molten salt reactor may include a subcritical region and a critical region. The subcritical region may define a subcritical volume for the storage of the fuel salt away from a reactor core. The critical region may define a critical volume for fission reactions and for circulation of a fuel salt through a fuel salt circuit of the critical volume. The critical region may be configured to promote the circulation of fuel salt by injecting inert gas bubbles into an elevated temperature flow of the fuel salt in the fuel salt circuit.

### CROSS REFERENCE TO RELATED APPLICATIONS

This application relates and claims priority to U.S. Provisional Application No. 63/767,330, filed Mar. 5, 2025, and entitled “BUBBLE-ENHANCED NATURAL CONVECTION REACTOR FLOW,” which is hereby incorporated by reference in its entirety.

### TECHNICAL FIELD

The described examples relate generally to systems, devices, and techniques for the promotion of natural convection in an integral molten salt reactor.

### BACKGROUND

Natural convection resulting from buoyancy of a volume of fluid that is at a higher temperature and therefore less dense than the surrounding fluid and can be used to facilitate heat removal through a heat exchanger. Nuclear reactors using natural convection can remove the need for mechanical pumps that require maintenance and can fail unexpectedly. While heat differentials in the fluid can be used to promote natural convection, the characteristics of the resulting flow, including flow rate and direction, can be difficult and impractical to precisely control. As such, there remains a need for improved systems and techniques that promote convection without mechanical pumps or other rotating equipment.

### SUMMARY

In one example, an integral molten salt reactor is disclosed. The integral molten salt reactor includes a subcritical region that defines a subcritical volume for the storage of the fuel salt away from a reactor core. The integral molten salt reactor further includes a critical region that defines a critical volume for fission reactions and for circulation of a fuel salt through a fuel salt circuit of the critical volume. The critical region is configured to promote the circulation of fuel salt by injecting inert gas bubbles into an elevated temperature flow of the fuel salt in the fuel salt circuit.

In another example, the critical region includes a bubbler configured to inject the inert gas bubbles proximal to an exit of a reactor core of the critical region, the reactor core configured to cause the fission reactions.

In another example, the bubbler is configured to inject the inert gas bubbles along an injection flow path toward a heat exchanger of the critical region, the heat exchanger disposed elevationally above the reactor core.

In another example, the bubbler is operable to generate inert gas bubbles having a size and a shape configured to promote elevationally upward movement of said inert gas bubbles and of the fuel salt associated therewith.

In another example, the integral molten salt reactor may further include an inert gas region defining an inert gas headspace along a boundary with the critical volume. In this regard, the inert gas headspace may be configured to receive the inert gas bubbles injected at the critical region.

In another example, the integral molten salt reactor may further include a mesh configured to extinguish the inert gas bubbles along the boundary.

In another example, the injected inert gas bubbles may enhance the buoyancy of the fuel salt through the elevated temperature flow segment of the fuel salt circuit. In this regard, the inert gas bubbles may enhance natural convection of the integral molten salt reactor therethrough.

In another example, a method of operating an integral molten salt reactor is disclosed. The method includes causing fission reactions in a fuel salt in a critical region of an integrally constructed vessel. The method further includes circulating the fuel salt through a fuel salt circuit of the critical region and removing heat therefrom. The circulating may include injecting inert gas bubbles into an elevated temperature flow of the fuel salt in the fuel salt circuit to encourage flow of the fuel salt through the fuel salt circuit.

In another example, the injecting of the inert gas bubbles may include injecting the inert gas bubbles along an injection flow path toward a heat exchanger of the critical region. The heat exchanger may be disposed elevationally above a reactor core within which said fission reactions occur.

In another example, the circulating may further include increasing a buoyancy of the salt using the inert gas and causing the fuel salt to travel elevationally upward toward and into the heat exchanger.

In another example, the method may further include popping the inert gas bubbles on entrance to an inert gas region of the integral molten salt reactor. The inert gas region may define a headspace along a boundary with a critical volume of the critical region.

In another example, the method may further include, in response to a shutdown event, draining the fuel salt to a subcritical region of the integrally constructed vessel.

In another example, the injection flow path may define a dedicated channel for the elevated temperature fuel salt that is separate from the lower temperature fuel salt. The lower temperature fuel salt may be disposed along a periphery of the integrally constructed vessel.

In another example, the injecting of the inert gas bubbles may further include injecting said inert gas bubbles adjacent to or along a centerline of the integrally constructed vessel.

In another example, an integral molten salt reactor is disclosed. The integral molten salt reactor includes an integrally constructed vessel defining a critical region. The integral molten salt reactor further includes a reactor core disposed within the critical region. The integral molten salt reactor further includes a bubbler disposed at an exit of the reactor core. The integral molten salt reactor further includes a heat exchanger disposed elevationally above the reactor core. The integral molten salt reactor further includes a fuel salt disposed throughout a fuel salt circuit including the reactor core and the heat exchanger. The integral molten salt reactor is configured to: (i) heat the fuel salt via fission reactions caused within the reactor core, (ii) circulate the fuel salt from the reactor core to the heat exchanger using an inert gas output from the bubbler, and (iii) export heat from the fuel salt at heat exchanger.

In another example, the integrally constructed vessel may further define a subcritical region. In this regard, the integral molten salt reactor may further include a drain tank disposed within the subcritical region. The heat exchanger, the reactor core, and the drain tank are fully enclosed within the integrally constructed vessel. Further, upon a shutdown event, the integral molten salt reactor may be configured to cause the fuel salt to gravitationally transfer to the drain tank by altering a pressure differential between the critical region and the subcritical region.

In another example, the integrally constructed vessel may include a sealed containment structure defining a containment volume. The integrally constructed vessel may be fully disposed within the containment volume.

In another example, the sealed containment structure may surround a fission product adsorbing/absorbing material positioned within the containment volume and radially outside of the integrally constructed vessel.

In another example, the bubbler may include an orifice having an orifice size and an orifice cross-section. In this regard, the orifice size and the orifice cross-section may be configured to produce inert gas bubbles of sufficient velocity to travel elevationally upward toward the heat exchanger.

In another example, the integral molten salt reactor may further include a popping mesh arranged elevationally above the heat exchanger and adjacent a boundary of an inert gas headspace. In this regard, the popping mesh may be configured to receive the inert gas output and dissipate bubbles formed therewith as said bubbles enter the inert gas headspace.

In addition to the example aspects described above, further aspects and examples will become apparent by reference to the drawings and by study of the following description.

### BRIEF DESCRIPTION OF THE DRAWINGS

FIG. 1 depicts an example integral molten salt reactor system including a bubbler of the present disclosure.

FIG. 2A depicts a drain tank section of the integral molten salt reactor system of FIG. 1.

FIG. 2B depicts a detail view of FIG. 2A.

FIG. 3A depicts a reactor section of the integral molten salt reactor system of FIG. 1.

FIG. 3B depicts a detail view of FIG. 3A.

FIG. 4A depicts a heat exchange section and a fission gas void section of the integral molten salt reactor system of FIG. 1.

FIG. 4B depicts a detail view of FIG. 4A.

FIG. 5 depicts a maintainable components section of the integral molten salt reactor system of FIG. 1.

FIG. 6A depicts a bubbler of the integral molten salt reactor system of FIG. 1.

FIG. 6B depicts the bubbler of FIG. 6A in an example configuration for variable positioning.

FIG. 6C depicts the bubbler of FIG. 6A in another example configuration for variable positioning.

FIG. 7 depicts a mesh screen of the bubbler of FIG. 6A.

FIG. 8 depicts a popping mesh of the integral molten salt reactor system of FIG. 1.

FIG. 9 depicts another example of a bubbler for the integral molten salt reactor system of FIG. 1.

FIG. 10 depicts a cross-sectional view of the bubbler of FIG. 9, taken along line 10 -10 of FIG. 9.

FIG. 11 depicts the integral molten salt reactor system of FIG. 1 in a first configuration.

FIG. 12 depicts the integral molten salt reactor system of FIG. 1 in a second configuration.

FIG. 13 depicts the integral molten salt reactor system of FIG. 1 in a third configuration.

FIG. 14 depicts another example of an integral molten salt reactor having another example bubbler of the present disclosure.

FIG. 15 depicts an injection flow path of the example bubbler of FIG. 14.

FIG. 16 depicts a flow diagram of a method of operating an integral molten salt reactor.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various embodiments of the present invention. However, it should be understood that the described embodiments may be practiced in a variety of forms in addition to those described herein.

The following disclosure relates generally to a “pool-type” molten salt nuclear reactor (referred to herein as an “MSR”). A pool-type MSR (referred to herein as an “integral” MSR) may generally refer to an MSR in which the functional components of the nuclear reactor may be disposed inside a common enclosure with the reactor core. An integral MSR may reduce or eliminate such leaks and/or other failure mechanisms by fully enclosing the functional components (e.g., the heat exchanger, the reactor core, the pump (if used), and so on) within a common, integrally constructed vessel. For example, integral MSRs may house a reactor core and one or more heat exchangers in a common vessel, and cause a fuel salt to circulate within the common vessel between the reactor core (at which the fuel salt may undergo a fission reaction that heats the salt) and a heat exchanger (at which the heat is removed from the fuel salt). The MSRs of the present application utilize a form of natural convection resulting from the buoyancy of a volume of fluid (e.g., molten fuel salt) contained therein, which is at a higher temperature than the surrounding fluid. Nuclear reactors using natural convection can remove the need for mechanical pumps that require maintenance and that can fail unexpectedly. Notwithstanding, while heat differentials in the fluid can be used to promote natural convection, the characteristics of the resulting flow, including the flow rate and direction, can be difficult or impractical to precisely control or predict. Further, such precise and predictable flow characteristics may be vital to both the safe operation of the MSR and approval of necessary regulatory requirements. As such, there remains a need for improved systems and techniques that promote convection without mechanical pumps or other rotating equipment, such as those that can be used to control characteristics of the naturally convective flow.

To mitigate these and other challenges, the integral MSR of the present disclosure includes a critical region that is configured to promote the circulation of fuel salt by injecting inert gas bubbles (i.e., bubbles of inert gas) into an elevated temperature flow of the fuel salt in a fuel salt circuit. The inert gas bubbles may be positioned, sized, shaped, and arranged in a manner to promote natural convection or circulation of the molten salt, as described herein. In this regard, the inert gas bubbles may be introduced into a flow of molten salt to support the characteristics of the flow as may be required to achieve certain operational parameters of the MSR. Additionally, the inert gas bubbles may also aid in the removal of gaseous fission products from the fuel salt. In this regard, the bubbler may provide a combinative benefit of promoting natural convection while also functioning to improve reactor performance by removing said gaseous fission products from the fuel salt. Further, in some configurations, the inert gas bubbles may be selectively positioned to establish a variable controlled gas flow. The addition of variable gas flows may provide capabilities to remove gaseous fission products, enhance flows and manage material properties in the regions of choice, as described herein.

In one example, the integral MSR of the present disclosure broadly includes the critical region and a subcritical region. The critical region may define a critical volume for the circulation of a fuel salt therethrough along a fuel salt circuit. The critical region may be the region of the integral MSR at which fission reactions primarily occur. In this regard, the critical region may include various functional components that facilitate the generation of heat, including having a reactor core and one or more heat exchangers disposed therein. In one example, the critical region includes the space occupied by the reactor core. The subcritical region may define a subcritical volume for the storage of the fuel salt away from a reactor core of the critical region. The subcritical region may be the region of the integral MSR at which fission reactions do not, do not substantially occur, or otherwise caused to cease occurring. The subcritical volume may be physically separated from the critical volume by an internal barrier or other dividing structure so that that fuel salt can be maintained away from the reactor core as needed. For example, during operation of the integral MSR, the fuel salt may be circulated within the critical volume. Then, in response to a shutdown event (including an event in which the integral MSR is shut down under emergency conditions, such as a loss of power), the fuel salt may be passively transferred from the critical volume to the subcritical volume, as described in detail herein.

The inert gas bubbles may be introduced into the integral MSR at the critical volume of the critical region in order to promote natural circulation therein and/or to aid in the removal of gaseous fission products from the fuel salt. For example, a bubbler arranged in the critical volume may introduce insert gas into a fuel salt circuit along which the fuel salt traverses during operation of the reactor. The fuel salt may travel along the fuel salt circuit through the reactor core where the fuel salt heats up due to the undergoing of fission reactions therein. The fuel salt may exit the reactor at an elevated temperature flow of the fuel salt circuit and may subsequently travel through one or more heat exchangers positioned elevationally above the reactor core. The fuel salt may exit the one or more heat exchangers at a lower temperature flow (following heat transfer to a coolant, such as a molten salt not having fissile material therein) of the fuel salt circuit, where the fuel salt may traverse the fuel salt circuit and return to the reactor core for repetition of foregoing fuel salt circuit thereby continually generating a heat output.

As described herein, the inert gas bubbles may be introduced at the elevated temperature flow of the fuel salt circuit by the bubbler—e.g., proximal an exit of the reactor core where the temperature of the fuel salt along the fuel salt circuit may be greatest. The inert gas bubbles may be injected directionally facing a headspace or topmost portion of a reactor vessel of the MSR. The inert gas bubbles may have a size, shape and/or composition configured to promote the elevationally upward movement of the inert gas and fuel salt associated therewith. The inert gas bubbles may generally comprise an inert gas or inert gas mixture. In this regard, the inert gas bubbles described herein may be composed primary or partially of nitrogen, helium, argon, other inert gas, or combinations thereof. For example, the inert gas bubbles may increase the buoyancy of the elevated temperature fuel salt and assist the elevated temperature fuel salt in reaching the one or more heat exchangers positioned elevationally above the reactor core. In this regard, injecting inert gas bubbles in the desired direction of flow can increase the buoyancy of the elevated temperature fuel salt existing the nuclear reactor core, thereby improving the natural convection of the overall system. This increase in natural convection can yield more reliable flow and potentially reduce system volume, which may reduce costs. Additionally or alternatively, the inert gas bubbles may be injected or otherwise cause to flow through areas of the fuel salt circuit anticipated to have low-flow or undesirable recirculation characteristics (e.g., a localized circular flow) thereby eliminating or at least mitigating the presence of such low-flow or undesirable recirculation areas by promoting flow thereat.

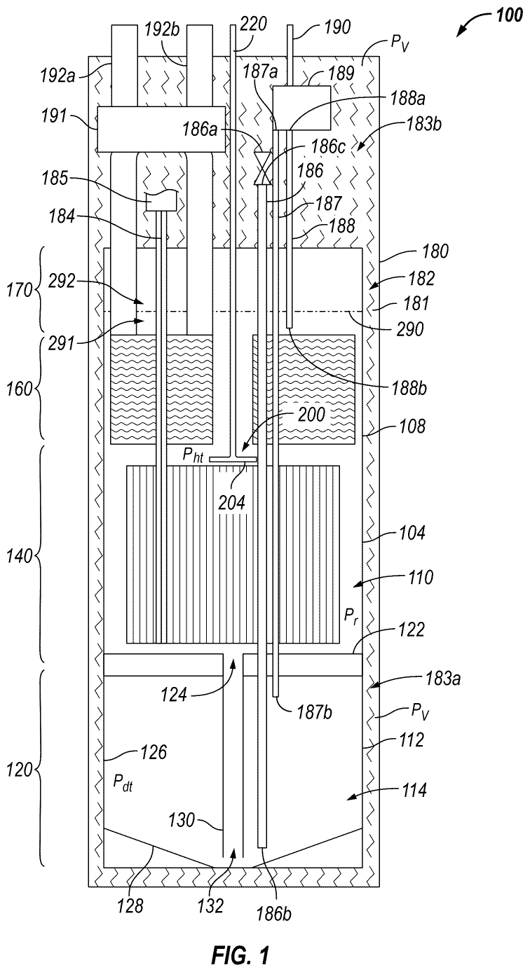

Turning to the Drawings, FIG. 1 depicts an example integral MSR system 100 including a bubbler 200 of the present disclosure. The integral MSR 100 may include an integrally constructed vessel 104, a critical region 108, a critical volume 110, a subcritical region 112, a subcritical volume 114, a drain tank section 120, an internal barrier 122, a fuel salt passage 124, a reactor section 140, and a heat exchange section 160, redundant explanation of which is omitted here for clarity. The integral MSR 100 may be configured to be shipped to a site as a pre-assembled unit, including being arranged to fit on a semi-tractor trailer such that the integral MSR 100 may be transported to a site using conventional trucking and highway infrastructure.

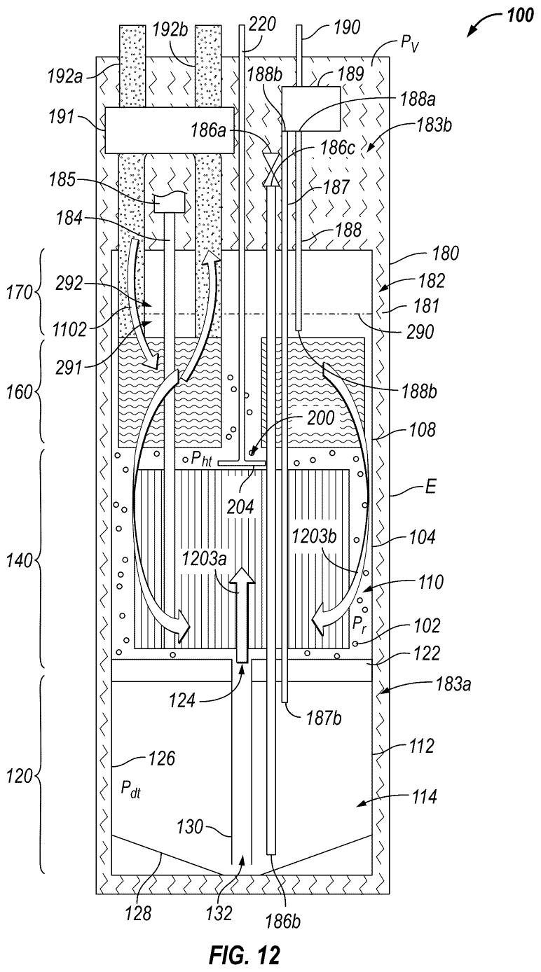

The integral MSR 100 is shown schematically as including a common, integrally constructed vessel 104. The vessel 104 may define both the critical region 108 and a subcritical region 112. The critical region 108 may define a critical volume 110 for the circulation of the fuel salt 102 and for the housing of fission reactions occurring therein. Further, the subcritical region 112 may define a subcritical volume 114 for the storage of the fuel salt 102 away from a reactor core or otherwise away from the critical region 104. As generally shown in FIG. 1, the critical region 108 may circulate the fuel salt 102 along a circulation flow path therein including along a fuel salt circuit (as shown in FIG. 12) through a reactor section 140 where the fuel salt 102 may generally be heated due to fission reactions occurring therein. As further shown in FIG. 1, the critical region 108 may circulate the fuel salt 102 along the fuel salt circuit therein including through a heat exchange section 160 and back to the reactor section 140 for recirculation therethrough. At the heat exchange section 160, heat may be removed from the fuel salt 102 in order to circulate a cooler fuel salt 102 back to the reactor section 140 so that the fuel salt 102 may again be heated along the fuel salt circuit. The circulation of the fuel salt 102 along the fuel salt circuit may proceed continuously in order to provide a generally constant, steady stream of heat from the fission reactions to the heat exchangers of the system 100. In at least one embodiment, the fuel salt 102 is a mixture of molten salt and fissile material. For example, the fuel salt 102 may be a LiF—BeF₂—UF₄ molten salt; however, other fluoride-based or chloride-based salts may be used. In at least one embodiment, the heat removed from the fuel salt 102 at the heat exchange section 160 is transferred to a coolant salt. The coolant salt may be a molten salt mixture not having a fissile material dissolved therein. Example coolant salt compositions include fluoride-based salts, chloride based salts, or other coolant salts known in the art. In at least one embodiment, the coolant salt is a LiF—BeF₂ molten salt.

The integrally constructed vessel 104 is shown in FIG. 1 as including the subcritical region 112 therein, which may establish a drain tank section 120 of the integral MSR 100. Accordingly, the integral MSR 100 may be operable to maintain the fuel salt 102 in both a critical state, and a subcritical state, within the same, integrally constructed vessel 104. The subcritical volume 114 of the subcritical region 112 is shown separated from the critical volume 110 by an internal barrier 122. The internal barrier 122 may further define a fuel salt passage 124 therethrough in order to establish a flow path for the fuel salt 102 between the critical volume 110 and the subcritical volume 114.

The fuel salt 102 may be selectively held within the critical volume 110 and/or the subcritical volume 114 based on the maintenance of an inert gas pressure within each volume. For example, the critical volume 110 may be held at a pressure Pᵣ and the subcritical volume may be held at a pressure P_{dt}. In the example of FIG. 1, in which the fuel salt 102 is circulated in the critical region 108, the integral MSR 100 may operate to maintain the pressure P_{dt} at a value that is greater than the pressure Pᵣ. Accordingly, the fuel salt passage 124 may be pressurized to mitigate or prevent the introduction of fuel salt 102 into the subcritical volume 114. As described herein, the pressures P_{dt}, Pᵣ may be manipulated in various manners in order to control the disposition of the fuel salt 102 as between the critical region 108 and the subcritical region 112.

FIG. 1 further depicts the integral MSR 100 as including a sealed containment structure 180, a sealed containment volume 182, a fission product adsorbing/absorbing material 181 (e.g., activated charcoal, various zeolites, bismuth-based materials, metal-organic frameworks, or other similar materials known in the art), an integral molten salt reactor section 183a, and a maintainable components section 183b. The integrally constructed vessel 104 is shown in FIG. 1 as being held in the molten salt reactor section 183a and surrounded substantially by the fission product adsorbing/absorbing material 181. In some cases, the molten salt reactor section 183a (and accompanying maintainable components section 183b) may be held at a pressure Pᵥ, which may be a vacuum pressure. In other cases, Pᵥ may be adapted based on the thermal requirements of the integral MSR 100. Additionally or alternatively, the molten salt reactor section 183a may be configured to receive gas that may be adapted for emergency cooling of the vessel 104, among other uses.

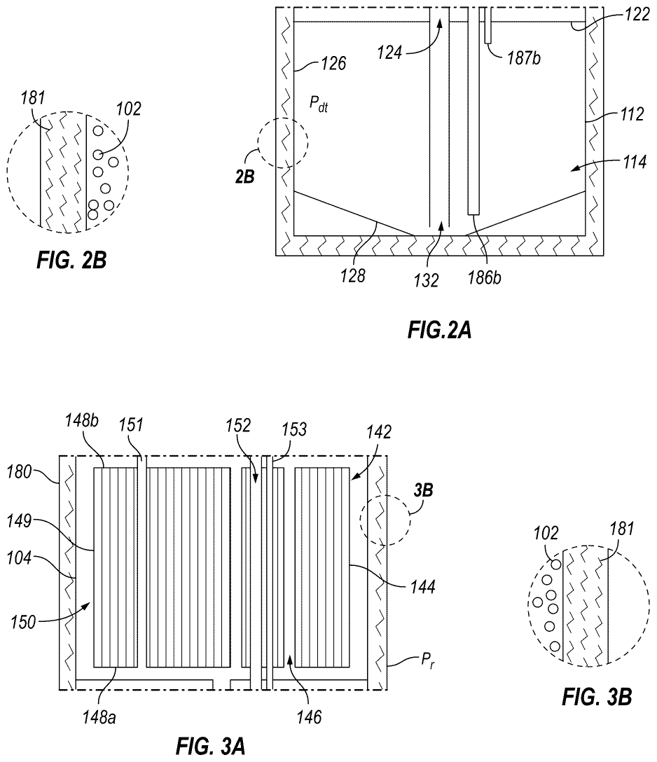

The integral MSR 100 may include the integrally constructed vessel 104 as having the drain tank section 120. The drain tank section 120 may be configured to hold a volume of fuel salt away from a reactor core and/or other components that occupy the critical region 108 of the integrally constructed vessel 104. For example, and with reference to FIGS. 1, 2A and 2B, the drain tank section 120 may be configured to hold the fuel salt in the subcritical volume 114, which may generally be defined collectively by the internal barrier 122, drain tank walls 126, and floors 128. With reference to the internal barrier 122, the internal barrier 122 may be a structural component that establishes a physical barrier and physical separation between fuel salt held in the critical volume 110 and fuel salt held in the subcritical volume 114. In this regard, the internal barrier 122 may have a sufficient strength and rigidity in order to support a weight of the fuel salt within the critical region 108 without undue deformation or encroachment of the internal barrier 122 into or toward the subcritical volume 114.

The internal barrier 122 may be adapted to permit the passage of fuel salt between the critical volume 110 and the subcritical volume 114 only via the fuel salt passage 124 defined through the internal barrier 122. In order to permit the transfer of fuel salt between the critical volume 110 and the subcritical volume 114, the drain tank section 120 may further include a transfer pipe 130. The transfer pipe 130 may extend from the fuel salt passage 122 toward a floor 128 of the drain tank section 120. As shown in FIGS. 1 and 2A, the floors 128 may be slopped to encourage fuel salt toward the transfer pipe 130. For example, an end of the transfer pipe 130 may have a mouth 132 that is disposed adjacent to the floors 128 of the drain tank section 120. In this regard, and as described in greater detail herein, fuel salt can be transferred from the subcritical volume 114 to the critical volume 110 until said fuel salt reaches an elevational level of the mouth 132 in the subcritical volume 114. In one example, the subcritical volume 114 includes a small volume of fuel salt (even when the majority of the fuel salt is disposed in the critical volume 110) at least sufficient to plug the mouth 132 of transfer line 130. In this regard, pressure P_{dt} may pneumatically push against this volume of fuel salt, thereby causing the majority of the fuel salt to remain in the critical volume 110, as described herein.

The integral MSR vessel 104 may include the reactor section 140. The reactor section 140 may be configured to receive a volume of fuel salt from the drain tank section 120 and cause fission reactions that heat the fuel salt. For example, and with reference to FIGS. 1, 3A, and 3B, the reactor section 140 may generally include a reactor core 142 formed at least partially from a moderator material 144, such as a graphite material. The reactor core 142 may cause or otherwise facilitate the undergoing fission reactions in the critical region 108. Accordingly, the reactor core 142 may be constructed in a manner to receive the fuel salt and to cause the fuel salt 102 to be heated therein. In this regard, the reactor core 142 is shown in FIG. 3A as having a fuel salt passage 146 that extends generally from a core bottom side 148a to a core top side 148b. As described herein, the fuel salt 102 may be encouraged to travel through the fuel salt passage 146, and in so doing, the fuel salt 102 may be heated by fission reactions. The reactor core 142 is further shown in FIG. 3A as having peripheral sides 149. The peripheral sides 149 may generally be transverse sides to the core bottom and top sides 148a, 148b. The peripheral sides 149 may be arranged in order to define a core section passage 150 between the reactor core 142 and the integrally constructed vessel 404. As described herein, the fuel salt 102 may be encouraged to travel through the core section passage 150 upon removal of heat from the fuel salt at the heat exchange section 160, and for subsequent recirculation into the core 142.

The reactor core 142 may further include various components to facilitate various other functions of the integral MSR 100. For example, the reactor core 142 is further shown in FIG. 3A as including a control rod accommodating portion 151. The control rod accommodating portion 151 may be a void or cavity that extends into the moderator material 144 and that is operable to receive one or more control rod structures and/or other structures that are operable to control reactivity of the core 142 (including components that may be used to slow or stop a nuclear reaction in core 142). Further, the reactor core 142 is shown in FIG. 3A as including a fuel loading accommodating portion 152. The fuel loading accommodating portion 152 may be a lumen, duct, or other through passage that allows for one or more fuel loading pipes to extend through the core 142 in order to reach the subcritical volume 114. In this regard, and as described herein, the subcritical volume 114 may be loaded with a fuel salt from a topmost region of the integral MSR 100, passed through the core 142, and stored in the drain tank section 120 below. The reactor core 142 is further shown in FIG. 3A as including an inert gas line accommodating portion 153. The inert gas line accommodating portion 153 may be a lumen, duct, or other through passage that allows for one or more inert lines or pipes to extend through the core 142 in order to reach the subcritical volume 114. In this regard, and as described herein the subcritical volume 114 may be pressurized with inert gas from a topmost region of the integral MSR 100.

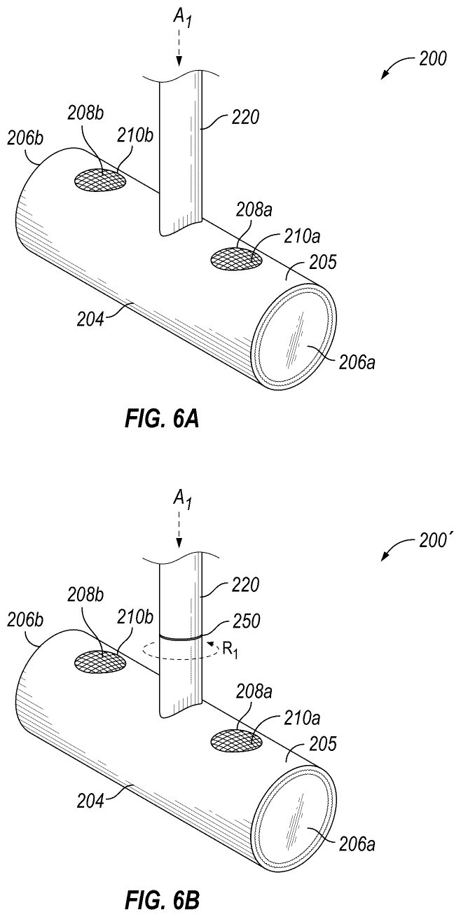

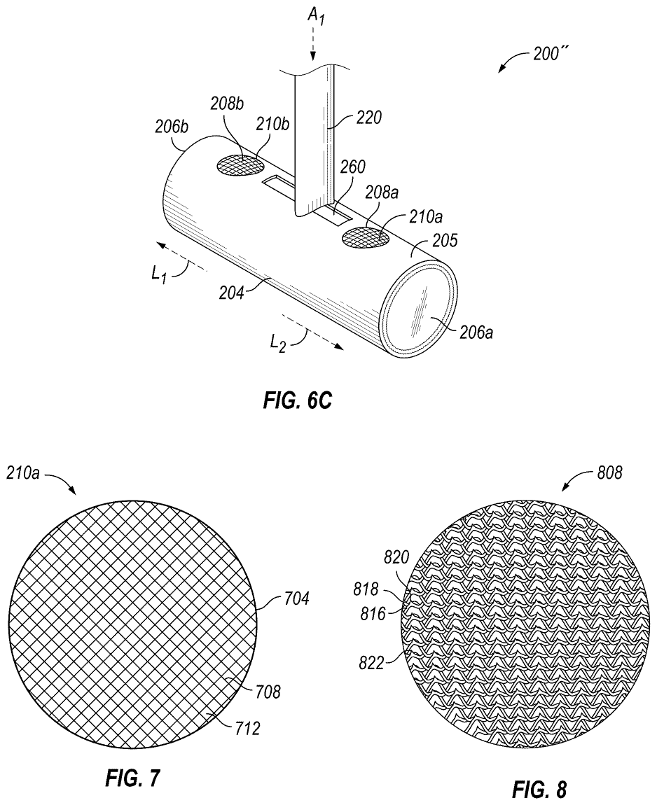

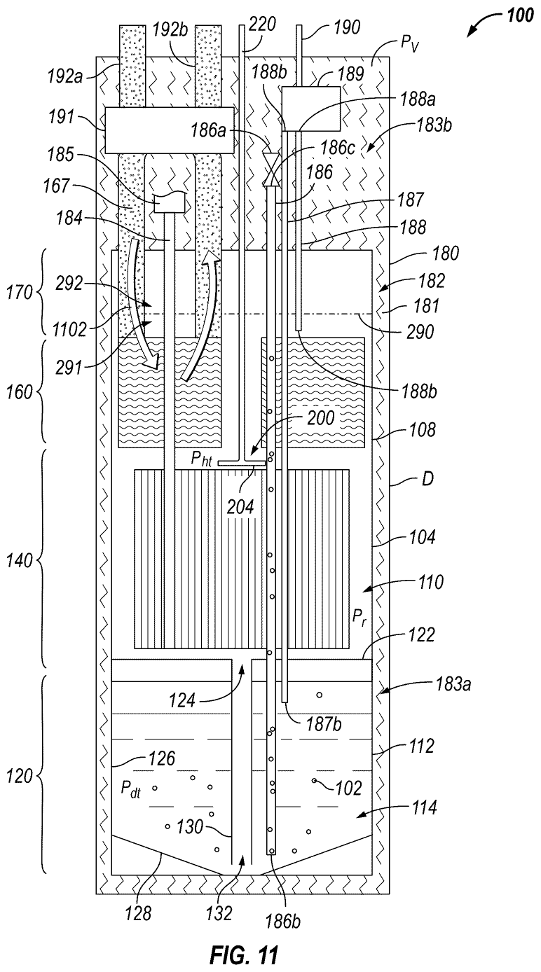

As shown in FIG. 1, the reactor section 140 may include the bubbler 200. The bubbler 200 may be positioned elevationally above the reactor core 142. In this regard, the bubbler 200 may be positioned within the fuel salt circuit along an elevated temperature flow of the fuel salt. The critical region 108 may therefore be configured to promote the circulation of the fuel salt along the fuel salt circuit by integrating the bubbler 200 therein, according to the example embodiments presented herein. The bubbler 200 may be configured to emit a flow of inert gas bubbles into the fuel salt. The emitted flow of inert gas bubbles by the bubbler 200 may promote natural convection while also functioning to improve reactor performance by removing or dislodging gaseous fission products from the fuel salt. As such in FIG. 1, the bubbler 200 may include an emission section 204 and a supply section 220. The supply section 220 may be a pipe, tube, conduit and/or other feature coupled with a supply of inert gas. For example, the supply section 220 may be used to deliver an inert gas to the emission section 204 from an inert gas source (e.g., vessel or other supply source) to the emission section 204 that is otherwise held within the reactor section 140. In turn, the emission section 204 may receive inert gas from the supply section 220 and route and deliver the inert gas to the fuel salt flow within the reactor section 140. For example, and as described in greater detail herein with reference to FIGS. 6 and 7, the emission section 204 may include one or more features that cause the inert gas to exit the bubbler emission section 204 and enter the fuel salt along a direction that faces a headspace of the reactor vessel 104. In this manner, the inert gas being emitted therefore may be configured to flow toward the reactor headspace while facilitating the movement of associated fuel salt therealong. For example, the emitted inert gas may increase a buoyancy of the fuel salt at the elevated temperature flow of the fuel circuit, which may promote the travel of the fuel salt along the flow circuit and toward the reactor vessel headspace and heat exchangers positioned adjacent thereto. The increase in buoyancy of the fuel salt may therefore facilitate travel of the fuel salt along the fuel salt circuit, as described further with reference to FIGS. 11-13.

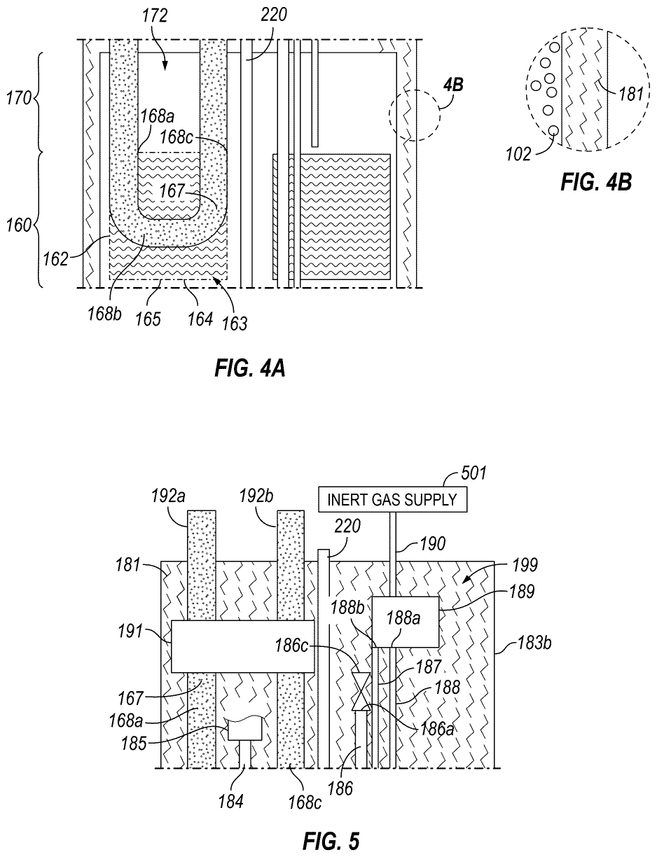

The integrally constructed vessel 104 may include the heat exchange section 160. The heat exchange section 160 may be configured to receive a flow of the heated fuel salt from the reactor section 140 and remove heat therefrom. For example, and with reference to FIGS. 1, 4A, and 4B, the heat exchange section 160 is shown as having a heat exchanger 162. The heat exchanger 162 may generally take of any of variety of forms in order to transfer heat from fuel salt of the critical volume 110 to a coolant salt or other medium that is held by the heat exchanger 162. In the example of FIG. 4A, the heat exchanger 162 is shown as including a shell 164 having passages 165 that lead into a heat exchange volume 163. Fuel salt (such as that which has been heated from one or more fission reactions) may be routed to the exchange volume 163. Within the volume 163, a coolant pipe run 166 having a coolant salt 167 disposed flowing there through may operate to remove heat from the fuel salt that is arranged in the exchange volume 163. In this regard, the coolant pipe run 166 may include a cold leg 168a, an interface section 168b, and a hot leg 168c. The cold leg 168a, the interface section 168b, and the hot leg 168c may cooperate to define a U-shaped member as shown in FIG. 4A; however, in other cases, other shapes and configurations are contemplated. The cold leg 168a may generally include the coolant salt in a reduced temperature format. The interface section 168b may be in contact with the heated fuel salt that traverses through the heat exchanger 162 in the exchange volume 163. In turn, the heat from the heated fuel salt may be transferred to the coolant salt 167 held within the interface section 168b. Subsequently, the coolant salt 167 in elevated temperature format (due to the transfer of heat from the fuel salt) may exit the heat exchanger 164 via the hot leg 168c. As described herein, the elevated temperature coolant salt 167 from the hot leg 168c may be used for a variety of purposes, including electrical power generation, chemical processes, and the like.

With further reference to FIG. 1 the fission gas void space 170 is shown, which may be a head space of the integrally constructed vessel 104 arranged above the heat exchanger section 160. Broadly, the fission gas void space 170 may be any volume of head or gas space that sits adjacent the fuel salt contained within the reactor vessel 104. The allowance of head space in the fission gas void space 170 may permit the collection of gases therein the evolve from the molten salt over the course of reactor operations. It will therefore be appreciated that the volume of the fission gas void space 170 may change over time as a function of the fluid level of the molten sat contained within the reactor vessel 104.

As further shown in FIG. 1, the fission gas void space may include or be associated with a popping mesh 290. The popping mesh 290, as described in greater detail at FIG. 8 herein, may be a structure to facilitate the rupturing, breaking or other popping of the inert gas bubbles that may be emitted from the emission section 204 of the bubbler 200, as described herein. For example, inert gas bubbles emitted from the emission section 204 may generally be caused to move through the fuel salt and up and into the headspace of the reactor vessel 104. It may be desirable to facilitate the popping of inert gas bubbles along a boundary of a fuel salt 291 and an inert gas 292 of the headspace. For example, popping the inert gas bubbles may reduce the turbulence of molten salt 291 and/or may generally encourage the molten salt 291 to circulate along the fuel salt circuit, as opposed to accumulating in the headspace. As another example, popping mesh 290 may cause the inert gas of the inert gas bubbles to escape from the fuel salt 291 or otherwise dissipate and move, for example, to the fission gas void space 170. In this regard, a wire mesh structure, as described in the example of FIG. 8, may be arranged along the interface of the molten fuel salt 291 and the inert gas 292 and may be configured to pop or break the inert gas bubbles on contact. In some cases, the popping mesh 290 may elevationally float with the reactor vessel 104, which floatation level may be based on a level of the molten salt held 291 therein.

The integral MSR 100 may further include a variety of other components to support the operation of the reactor. Such components may be maintainable or replaceable components for which it may be desirable to arrange such components in a contained volume to mitigate the release of any gases therefrom. In this regard, and with reference to FIGS. 1 and 5, the integral MSR 100 is shown as associated with a collection of maintainable components 199. The maintainable components 199 are shown as being arranged in the maintainable components section 183b of the containment volume 182. The maintainable components 199 are further shown as being surrounded and encompassed by the fission product adsorbing/absorbing material 181.

In the example of FIGS. 1 and 5, the maintainable components 199 are shown as including a control rod 184 and as associated reactivity control system 185. The control rod 184 may be a calibrated piece of metal that is selectively lowered and raised into the reactor 142 in order to reduce or stop a nuclear reaction occurring therein. The reactivity control system 185 may include any of a variety of mechanical components that are configured for control the reactivity control elements described herein. In one example, the reactivity control system 185 may include certain gears, levers, and other mechanisms that allow for the control rod 184 to be selectively raised or lowered into the reactor vessel 105. As further shown in FIG. 1, the integral MSR 100 may be associated with a fuel load line 186. The fuel load line 186 may be a pipe or conduit that is operable to carry a fuel salt from an environment exterior to the integral MSR 100 to the subcritical volume 114. For example, the fuel load line 186 may including a loading end 186a that is arranged outside of the integrally constructed vessel 104 and that is adaptable to receive a load of fuel salt therein, such as through a valving 186c. The fuel load line 186 may further include a dispending end 186b that is arranged within the subcritical volume 114. In this regard, the fuel salt received at the loading end 186a and valving 186c may be routed to through the fuel load line 186 and to the subcritical volume 114 for dispensing thereto via the loading end 186a.

As further shown in FIGS. 1 and 5, the integral MSR 100 may include a pair of inert gas lines, including a subcritical gas line 187 and a critical region gas line 188. Each of the gas lines 187, 188 may be operable to control a pressure in the integrally constructed vessel 104. For example, the subcritical gas line 187 may have a loading end 187a that is operable to receive a flow of inert gas for routing to a dispensing end 187b that is arranged within the subcritical volume 114. Accordingly, a flow of inert gas can be controlled in order to control a pressure P_{dt} of the subcritical volume 114, thereby controlling a pressure in the drain tank section 120. Further, the critical gas line 188 may have a loading end 188a that is operable to receive a flow of inert gas for routing to a dispensing end 188b that is arranged with the critical volume 110. Accordingly, a flow of inert gas can be controlled in order to control a pressure Pₕₜ of the heat exchange section 160 of the critical volume 110, and to control a pressure Pᵣ of the reactor section 140 of the critical volume 110.

The inert gas lines 187, 188 may each be coupled with an inert gas system 189. The inert gas system 189 may include any of a variety of pumps, compressors, controllers and the like that are configured to cooperate to control the delivery of inert gas to the integrally constructed vessel 104 and the maintenance of pressure in the critical region 108 and subcritical region 112. For example, the inert gas system 189 may receive a supply of inert gas from supply line 190 that is ultimately coupled with an inert gas supply 501 of FIG. 5. In some cases, the inert gas supply 501 may be a vessel containing inert gas and/or other source of inert gas.

With further reference to FIGS. 1 and 5, such maintainable components 199 may include a coolant system 191. The coolant system 191 may generally include any of a variety of components that allows the coolant salt 167 to be exchanged with the heat exchanger 162 within the integrally constructed vessel 104 and to extract heat from said coolant salt 167 for use in additional processes. Accordingly, the coolant system 191 may include a secondary heat exchanger, such as any appropriate type of heat exchanger that operates to remove the heat from the coolant salt 167. In this regard, coolant system 191 may receive the hot leg 168c of the coolant pipe run 166, and transfer said heat to a secondary coolant that enters the coolant system 191 in a lower temperature format into via a cold leg 192a. The coolant system 191 may then cause the secondary coolant to exit the coolant system 191 at a secondary coolant hot leg 192b, which may be further routed to various other external processes, including those used for electricity generation, chemical processes, and the like.

The integral MSR 100 may further include a variety of other components and systems to support the operation of the reactor. In several embodiments, integral MSR 100 may include an off-gas system and/or gas management system generally operable to manage the various gases used by integral MSR system 100 during operation (e.g., inert gas system 189, the bubbler 200), present within the sealed containment structure 180 (e.g., fission gas void section 170), and generated via operation of integral MSR system 100 (e.g., gaseous fission products and aerosol streams coming from the fuel salt 102). In this regard, the off-gas and/or gas management system may be functionally coupled to the sealed containment structure 180 and operable to receive gas therefrom and input gas thereto. For example, the off-gas and/or gas management system may include pipes at gas removal locations to gas holdings tanks, activated charcoal beds, gas handling units, compressors, valves, controllers, monitors, ducts, and other components understood by those skilled in the art in managing gases during reactor operations. In several embodiments, the off-gas and/or gas management system is operable to receive the inert gas of the inert gas bubbles of bubbler 200, for example following rupturing, breaking or other popping of the inert gas bubbles by popping mesh 290. The inert gas may be received, processed, cleaned, purified, and/or recirculated back to bubbler 200 via off-gas and/or gas management system. In this regard, integral MSR 100 may be equipped to handle a continuous or semi-continuous inert gas bubble stream from bubbler 200 and avoid pressure build up.

As shown throughout FIG. 1-5, the collection of maintainable components 199 may be surrounded by the fission product adsorbing/absorbing material 181. For example, the fission product adsorbing/absorbing material 181 may be disposed throughout the containment volume 182 so that any components disposed therein are at least partially encompassed by the fission product adsorbing/absorbing material. With reference to FIG. 1, the fission product adsorbing/absorbing material 181 is shown arranged in the integral molten salt reactor section 183a such that the fission product adsorbing/absorbing material 181 surrounds the integrally constructed vessel 104. Further shown in FIGS. 1 and 5, the fission product adsorbing/absorbing material 181 is arranged in the maintainable components section 183b such that the fission product adsorbing/absorbing material 181 surrounds some or all of the collection of maintainable components 199. In this regard, in the events of a leak or emission of fission gases from the maintainable components 199, such gas may be captured by the fission product adsorbing/absorbing material 181 and additionally contained within the containment volume 182 of the sealed containment structure 180. The fission product adsorbing/absorbing material 181 may be substantially any material known in the art to adsorb/absorb fission products. For example, the fission product adsorbing/absorbing material 181 may be or at least composed of activated charcoal, various zeolites, bismuth-based materials, or metal-organic frameworks.

Turning to FIG. 6A, the bubbler 200 presented above in relation to FIG. 1, is described in greater detail below. The bubbler 200 is shown in FIG. 6A as including the emission section 204 and the supply section 220. The supply section 220 is shown as a conduit that is configured to receive a flow of inert gas A₁. The emissions section 204 may be welded or otherwise coupled to the supply section 220 and configured to receive inert gas from said flow. Each of the supply section 220 and the emissions section 204 may be constructed from a corrosion resistant material, such as from various stainless-steel materials. In this regard, the emissions section 204 may include a body 205. The body 205 may be a hollow tube that is welded or otherwise coupled with the supply section 220. The body 205 may include or be associated with end caps 206a, 206b such that the hollow interior of the body 205 is largely sealed from a surrounding environment. The body 205 may define ports 208a, 208b. The port 208a, 208b may be through portions that extend through a thickness of a wall of the body 205 to define passages between the hollow interior of the body 205 (which may be filled with inert gas) and a surrounding environment. In this regard, and as described herein, inert gas within the emission section 204 may exit the emissions section 204 at the ports 208a, 208b and into the flow of fuel salt for increasing the buoyancy therein. The ports 208a, 208b, as shown in FIG. 6A, are positioned on a top side of the body 205, facing a direction of the supply section 220. In this regard, the ports 208a, 208b may be calibrated to cause inert gas emitted therefrom to flow to the headspace of the reactor vessel 104, as described in relation to FIG. 1.

In the example of FIG. 6A, the emissions section 204 may further include mesh screens 210a, 210b. The mesh screens 210a, 210b may sit in and substantially cover an opening defined by each of the respective ports 208a, 208b, as shown in FIG. 6A. The mesh screens 210a, 210b may be configured to facilitate a size, shape and texture of the inert gas bubbles that are emitted from the emissions section 204. For example, the mesh screens 210a, 210b may include a mesh having certain openings tuned to create inert gas bubbles from inert gas that passes therethrough. The mesh screens 210a, 210b may also help mitigate back flow of the molten salt into the emissions section 204, which in turn may help reduce plugging or other blockage.

In some example configurations, the bubbler 200 may be configured for variable positioning of the bubbles emitted therefrom. For example, the bubbler 200, or any of the bubblers of the present disclosure, may be actuatable to position the emitted bubbles in a desired direction, as may be needed in support of natural convection and gaseous fission product removal. In this regard, FIG. 6B shows a bubbler 200′. The bubbler 200′ is shown as a variation of the bubbler 200 in which a rotational joint 250 is included in the supply section 220. The rotational joint 250 may permit movement of the emissions section 204 about rotational axis R₁ of the supply section 220. In some cases, the rotational joint 250 may be actuatable so as to selectively position the emissions section 204 as need about the rotational axis R₁. As a further example, FIG. 6C shows a bubbler 200″. The bubbler 200″ is shown as a variation of the bubbler 200 in which a lateral track 260 is included in the emissions section 204. The lateral track 260 may permit movement of the emissions section 204 along one or both lateral directions L₁ and L₂ of the emissions section 204. In some cases, the lateral track 260 may be actuatable so as to selectively position the emissions section 204 as needed about the lateral directions L₁ and L₂.

The addition of variable gas flows may provide capabilities to remove gaseous fission products, enhance flows and manage material properties in the regions of choice. These and other functionalities may allow for modification of spectral characteristics of the reactor core regions on demand. In this regard, this design feature may provide operational core reactivity control capabilities as well as fuel utilization enhancement capability.

Continuing the example, of FIG. 6A-6C, an example mesh screen 210a is shown in relation to FIG. 7. The mesh screen 210a is shown as including a boundary ring 704, a mesh grating 708 and passages 712. In other examples, other configurations of the mesh screen 210a are possible and contemplated herein. The boundary ring 704 may be a generally rigid member that mates with a perimeter of a respective port 208a. The mesh grating 708 may be a lesser gauge wiring or other corrosive-resistant material that is arranged across the boundary ring 704 in a manner to create the passages 712 therebetween. The passages 712 may be sized and shaped to produce inert gas bubbles having the desired characteristics.

In several embodiments, the inert gas bubbles are sized to encourage natural convection flow. For example, the bubbler 200 may be operable to generate inert gas bubbles having a microbubble size (i.e., having a diameter of less than 100μm). As another example, bubbler 200 may be operable to generate inert gas bubbles having a fine bubble size (i.e., having a diameter between 0.1 and 1 mm). As another example, bubbler 200 may be operable to generate inert gas bubbles having a diameter greater than 1 mm. In at least one embodiment, bubbler is operable to generate inert gas bubbles having a diameter of 1 to 5 mm. In several embodiments, the inert gas bubbles are shaped to encourage natural convection flow. For example, bubbler 200 may be operable to generate inert gas bubbles having an ellipsoidal or cap-shaped bubble.

Turning to FIG. 8, an example popping mesh 808 is depicted. The popping mesh 808 may be substantially analogous to the popping mesh 290 described and depicted in reference to FIG. 1. In this regard, the popping mesh 808 may be used to facilitate a breaking or rupturing of the inert gas bubbles as said inert gas bubbles reach the headspace of the reactor. In the example of FIG. 8, the popping mesh 808 is shown as including an interwoven wire grating including woven metal strands 816, 818 The woven metal strands 816, 818 may be jagged pieces of metal or otherwise formed in a manner to come to a series of points 820. The points 820 may be sharp or angled portions of the metal strands 816, 818 that area configured to contact an inert gas and bubble and pop said bubble on contact. Further, the metal strands 816, 818 may be arranged in a manner to define passages 822 therebetween. The passages 822 may permit inert gas to flow through the popping mesh 808 and enter the headspace of the reactor 104. In this regard, the popping mesh 808 may serve as a boundary through which molten salt does not generally pass, while the inert gas may pass therethrough. The popping mesh 808, as described in relation to FIG. 1, may be a floating structure configured to raise and lower with the reactor vessel 104 during operation based in part on a level of the molten salt fluid held therein. Advantageously, popping mesh 808 may be generally operable to rupture the inert gas bubbles described herein so that they diffuse from the fuel salt and migrate, for example, into the fission gas void section 170.

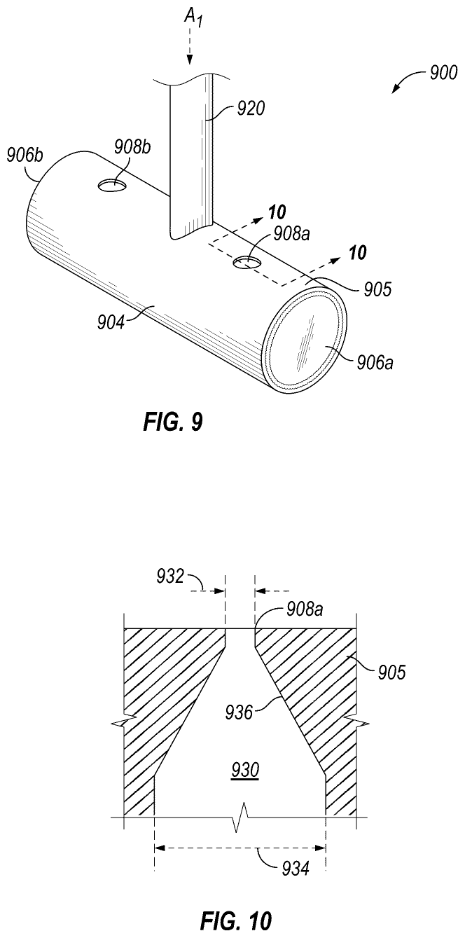

With reference to FIGS. 9 and 10, another example bubbler is depicted. For example, FIG. 9 shows a bubbler 900. The bubbler 900 may be substantially analogous as the bubbler 200 shown and described above in relation to FIGS. 1 and 6, and therefore include an emissions section 904, a supply section 920, a body 905, end caps 906a, 906b, ports 908a, 908b, and inert gas A₁; redundant explanation of which is omitted here for clarity. In this regard, the bubbler 900 may be configured to receive a supply of insert gas and route said inert gas into an elevated temperature flow of the molten salt. Notwithstanding the foregoing similarities, the ports 908a, 908b are shown in FIG. 9 as free from any obstructions, coverings, grates, meshes or other features. Rather, the ports 908a, 908b may be configured to directly emit inert gas and channel said inert gas from an interior of the emissions section 904 to a surrounding environment.

In this regard, and as depicted in the cross-sectional view of example port 908a of FIG. 10, at least a portion of the body 905 may be shaped or configured as a nozzle through which the inert gas is omitted from the emissions section 904. For example, the body 905 is shown in FIG. 10 as defining a port cavity 930. The port cavity 930 may have a nozzle entry diameter 934, an angled transaction section 936, and a nozzle exit diameter 932. Pressurized inert gas A₁ may therefore move from the hollow interior of the emissions section 904 and into the cavity 930 at the nozzle entry diameter 934. In turn, the inert gas may progress through the cavity 930 along the angled transition portion 936, and out of the port 908a at the nozzle exit diameter 932. The foregoing progression of large to small diameter may impact certain characteristics to the inert gas, including enhanced flow rate, which may be tuned to produce inert gas bubbles having desired characteristics. For example, it may be desirable for the bubbler 900 to produce inert gas bubbles having certain size, shape, speed and/or other characteristics. The size of the nozzle entry diameter 934, the angled transaction section 936, and the nozzle exit diameter 932 may cooperate to produce inert gas having such desired characteristics. For example, ports 908a, 908b may be configured to produce inert gas bubbles having a diameter of 1 mm to 5 mm and/or having an ellipsoidal or cap shape. Advantageously, such bubble characteristics may avoid slug formation, keep gas injection moderate, avoid coalescence dominance, and/or otherwise promote natural convection flow of the fuel salt with the seal containment structure (e.g., along fuel salt circuit).

With reference to FIG. 11-13, certain operational states of the MSR 100 are shown and described, including the use of the bubbler 200 to increase buoyancy of fuel salt circulating along a fuel salt circuit. In operation, the integral MSR 100 may be used to selectively control a disposition of the fuel salt 102 as between the critical volume 110 and the subcritical volume 114. The integral MSR 100 may further in operation be used to generate heat through fission reactions, which heat may be removed through the continuous circulation of fuel salt with the critical volume 110 and through the heat exchange section 160. In this regard, for the sake of illustration, FIG. 11 depicts the integral MSR 100 in a first configuration D. In the first configuration D, the integral MSR 100 may use a coolant salt or gas to heat the vessel 104. For example, the coolant salt 167 may be routed through the heat exchanger 162 along circulation path 1102. On startup, in the configuration D shown in FIG. 11, the coolant salt 167 may have an elevated temperature profile as compared to an ambient temperature of the vessel 104, thereby permitting the coolant salt 167 to heat the vessel 105 in the configuration D. In some cases, a heated gas may be used in place of the coolant salt 167 to heat the vessel 104. As is further shown in the first configuration D, the fuel salt 102 may be loaded into the subcritical region 114. For example, the fuel 102 salt may be introduced into the fuel load line 186 and caused to flow into the subcritical volume 114 via the fuel load line 186.

The integral MSR 100 may be further operable to cause the fuel salt 102 to selectively transfer from the subcritical region 114 to the critical region 110. For example, the inert gas lines 187, 188 may be operated in order to control a pressure in each of the critical volume 110 and the subcritical volume 114 and to create a pressure differential therebetween that causes the selective transfer of fuel salt between the critical and subcritical volumes 110, 114. To illustrate, FIG. 12 shows a loading of the fuel salt 102 into the critical volume 110 from the subcritical volume 114 and operation of the integral MSR 100 in a second configuration E. To accomplish said loading, inert gas may be provided to the subcritical region gas line 187 in order to cause the pressure P_{dt} of the subcritical region 112 to increase relative to the pressures Pₕₜ, Pᵣ of the critical region 110. The fuel salt 102 held with the subcritical volume 114 may be exposed to both the pressure P_{dt} and the pressure Pᵣ (via the transfer pipe 130). Accordingly, the pressure differential as between P_{dt} and Pᵣ may induce a flow of the fuel salt 102 from the subcritical volume 114 (having a higher pressure) to the critical volume 110 (having a lower pressure) that causes the fuel salt 102 to transfer from the subcritical volume 114 to the critical volume 110 via the transfer pipe 130. In order to maintain the fuel salt 102 in the critical volume 114, the pressure P_{dt} may be maintained at a higher pressure than either Pᵣ or Pₕₜ during the operation of the reactor. Upon entry of the fuel salt 102 into the critical region 108, the fuel salt 102 may be circulated along a circulation path 1203a extending up through the reactor core 142 where the fuel salt 102 may undergo a fission reaction that heats the fuel salt 102. The fuel salt 102 may be received by the heat exchanger 162 of the heat exchange section 160 from the circulation path 1203a in order to remove the heat from the fuel salt 102, such as via the coolant salt 167 traversing the circulation path 1102, as described herein). Subsequently, the fuel salt may proceed along a circulation path 1203b that extends along a periphery of reactor 142, such as through the core section passage 150 in order to return the fuel salt 102 to the reactor core 142 for further fission reactions, operating a continuous loop in this manner during operation of the integral MSR 100. The circulation paths 1203a, 1203b may, collectively, define the fuel salt circuit of the MSR 100.

As shown in FIG. 12, the bubbler 200 may operate to introduce inert gas bubbles into the integral vessel 104. The introduction of inert gas bubbles in the vessel 104 by the bubbler 200 is configured increase the buoyancy of molten salt circulating therein, which in turn may improve the natural convection of the system and/or aid in the removal of gaseous fission products from the fuel salt. For example, the bubbler 200 may be configured to emit inert gas toward a direction of the headspace of the vessel 104 as defined by the fission gas void section 170. The bubbler 200 may be positioned such that it emits the inert gas along an elevated temperature flow of the molten salt along the fuel salt circuit. For example, the bubbler 200 is shown positioned generally proximal an exit of the reactor core, at which the molten salt may be at a peak temperature in the fluid circuit due to the undergoing of fission reactions with the core. By emitting the inert gas into the flow at this junction, the elevated temperature molten salt may be more rapidly and directly routed toward the heat exchangers of the systems for removal of heat therefrom. Accordingly, this improvement in the natural convection can yield more reliable flow and potentially reduced system volume, which may help reduce costs. Further in the configuration of FIG. 12, the popping mesh 290 may operate to pop or rupture or break any insert gas bubbles that reach the fission gas void space 170. In this regard, the popping mesh 290 may help reduce unwanted flow characteristics or agitation of the molten salt along a boundary between the fuel salt 291 and the inert gas 292.

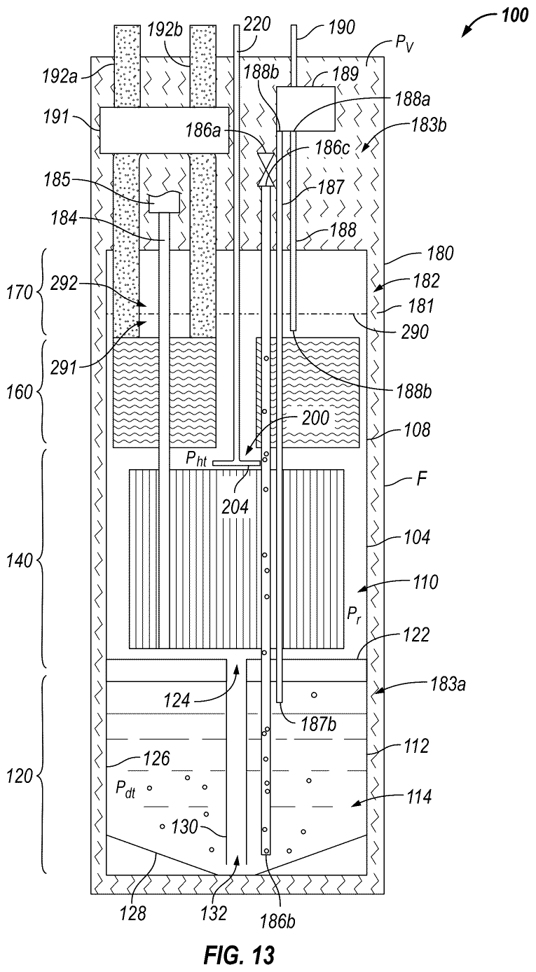

The configuration E of the integral MSR 100 shown in reference to FIG. 12 may be considered an active state of the reactor because the configuration E requires the ongoing, continuous pressurization of the fuel salt passage 124 in order to retain the fuel salt 102 in the critical region 108. Upon depressurization of the fuel salt passage 124 (and upon depressurization of the subcritical volume 114 more generally), the fuel salt 102 may flow, passively and gravitationally from the critical volume 110 to the subcritical volume 114 via the fuel salt passage 124. In this regard, FIG. 13 shows a third configuration F of the integral MSR 100 in which the fuel salt 102 is caused to flow from the critical volume 110 to the subcritical volume 114. For example, the subcritical region gas line 187 and the critical region gas line 188 may be operational in order to cause the pressure P_{dt} to be less than or equal to the pressures Pᵣ, Pₕₜ. On the establishment of such pressures, the fuel salt 102 may no longer be prevented from entering the drain tank section 120, and may therefore flow freely thereto. On flowing freely into the drain tank section 120, the fuel salt 102 may be positioned away from the reactor core 142 and/or generally away from components of the integral MSR 100 that may otherwise cause the fuel salt 102 to be heated. In this regard, the fuel salt 102 may be allowed to be cooled and stored safely during a shutdown event in the subcritical volume 114. Further, the change in pressure P_{dt} may be caused by either an intentional event (e.g., such the lowering of the pressure P_{dt}) or an unintentional event (e.g., an emergency loss of power or other event that results in the failure of the integral MSR 100 to maintain the pressure P_{dt}). Accordingly, the drain tank section 120 may serve as a passive safety system that collects the fuel salt 102 away from the reactor core 142 during an emergency event because said emergency event causes the fuel salt 102 to be routed to subcritical geometry of the drain tank section 120 by default.

The integral MSR 100, as shown in FIGS. 11-13 provides a passive safety system that operates, passively, in each of the configurations D-F described above. For example, the integral MSR 100 includes the sealed containment structure 180 such that the containment volume 182 fully about the integral reactor vessel 104 so that the integral vessel 104 is fully enclosed therein. The containment volume 182, as described herein, is filled with the fission product adsorbing/absorbing material 181. In this regard, in the event of a release event of gas from the integral vessel 104, in any of the configurations D-F, such gases may be trapped by the fission product adsorbing/absorbing material 181 and contained within the containment volume 182 of the sealed containment structure 180. Similarly, in the event of a release event of gas from any components of the collection of maintainable components 199, such gases may be trapped by the fission product adsorbing/absorbing material 181 and contained within the containment volume 182 of the sealed containment structure 180. This redundant and passive safety system, in connection with the fission gas void space 170, as described herein, may allow the integral vessel 104 to be constructed and operated free from any off-gas system. For example, gas from the fuel salt 102 may be fully contained by the fission gas void space 10, and the adjacent fission product adsorbing/absorbing material 181 and containment volume 182 may provide passive safety redundancy in the event of any release event of said gas, thereby reducing or eliminating the need for an off-gas system.

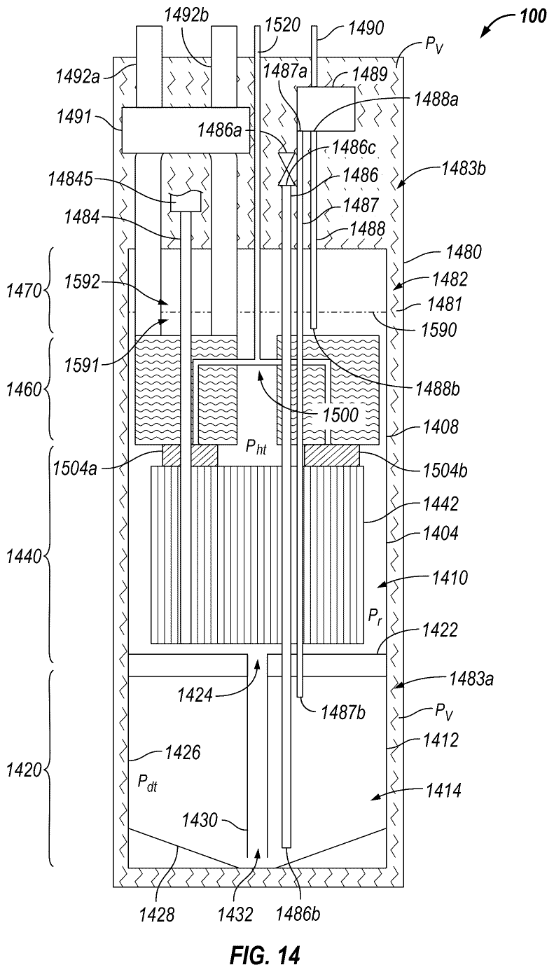

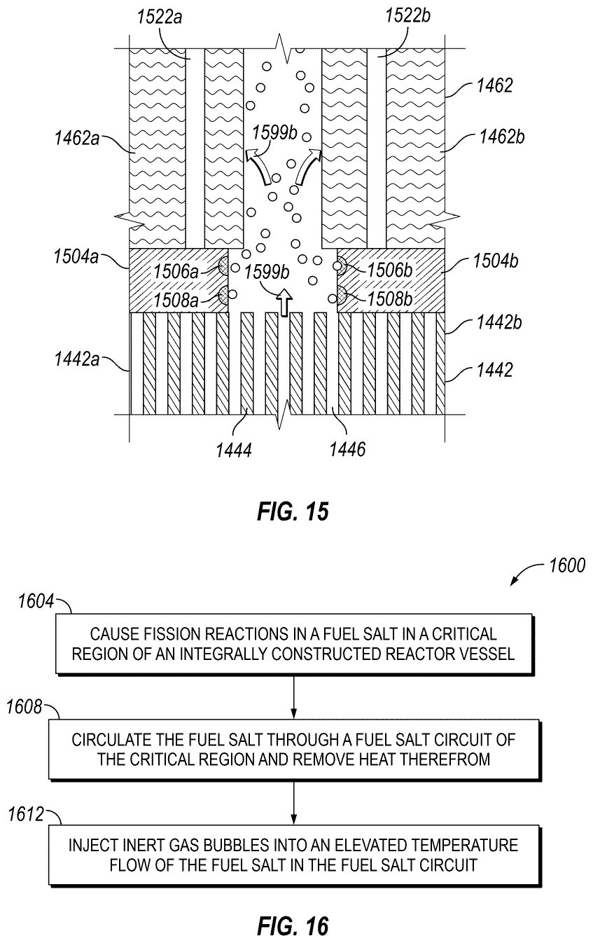

With reference to FIGS. 14 and 15, another example integral molten salt reactor system is shown. For example, FIG. 14 shows a schematic view of a molten salt reactor system 1400. The molten salt reactor system 1400 may be substantially analogous to the molten salt reactor system described in relation to FIG. 1 and may therefore include vessel 1404, critical region 1408, critical volume 1410, subcritical region 1412, subcritical volume 1414, drain tank section 1420, internal barrier 1422, fuel salt passage 1424, drain tank walls 1426, floors 1428, transfer pipe 1430, mouth 1432, reactor section 1440, reactor 1442, moderator material 1444, fuel salt passage 1446, heat exchange section 1460, heat exchanger 1462, fission gas void space 1470, sealed containment structure 1480, fission product adsorbing/absorbing material 1481, sealed containment volume 1482, integral molten salt reactor section 1483a, maintainable components section 1483b, control rod 1484, reactivity control system 1485, fuel load line 1486, loading end 1486a, dispensing end 1486b, valving 1486c, subcritical gas line 1487, loading end 1487a, dispensing end 1487b, critical region gas line 1488, loading end 1488a, dispensing end 1488b, inert gas system 1489, supply line 1490, coolant system 1491, cold leg 1492a, hot leg 1492b; redundant explanation of which is omitted herein for clarity.

Notwithstanding the foregoing, FIG. 14 shows the integral molten salt system 1400 as including a bubbler 1500. The bubble 1500, similar to the bubbler 200 of FIG. 1, may generally be configured to route inert gas and emit inert gas into a flow of molten salt of a molten circuit defined within the reactor. In this regard, the critical region 1408 may be configured to promote the circulation of the fuel salt therein in injecting gas bubbles into the elevated flow of molten salt using said bubbler 1500. Accordingly, the bubbler 1500 is shown has having a supply section 1520 and emission sections 1504a, 1504b. The supply section 1520 may be configured to route a flow of inert gas to each of the emission sections 1504a, 1504b. Analogous to the emission section 204 described in relation to FIG. 1, the emission section 1504a, 1504b may be configured to emit a flow of inert gas into molten salt of the fuel salt circuit.

Notwithstanding, the emission sections 1504a, 1504b may be integrated with functional and structural components of the reactor. For example, and as show in FIGS. 14 and 15, the emission sections 1504a, 1504b may be coupled with one or both of the heat exchanger 1462 and the reactor core 1442. In some cases, as shown in the detail view of FIG. 15, the emission sections 1504a, 1504b may be structural components that define a dedicated channel for flow of the molten salt from the reactor core 1442 and the heat exchangers 1462 along a centerline of the reactor 1442. In this regard, the emission sections 1504a, 1504b may operate to both introduce a flow of inert gas into the molten salt flow (thereby facilitating natural convection, as described herein), while also operating to channel and physically direct the flow of molten salt to the one or more heat exchangers 1462 positioned elevationally above the reactor core 1442 along a dedicated flow channel.

By way of particular example, FIG. 15 shows a first of emission section 1504a positioned between a heat exchanger section 1462a and a reactor core section 1442a. An inert gas conduit 1522a of the supply section 1520 is shown in the example of FIG. 15 as delivering a flow of inert gas to the first emission section 1504a. The first emission section 1504a may, in turn, include emission ports 1506a, 1508b that receive the flow of inert gas and deliver said inert gas to the flow of molten salt exiting the reactor core 1442. The emission ports 1506a, 1508b may be substantially analogous to any of the emission ports described herein, such as the ports 208a, 208b of FIG. 6A and/or the ports 908a, 908b of FIG. 9. In similar fashion, FIG. 15 also shows an inert gas conduit 1522a, the second emission section 1504b, and emission ports 1506b, 1508b.

In operation, an elevated temperature flow 1599a of molten salt may exit the reactor core 1442. For example, the molten salt may exit the reactor core 1442 at one or more fuel salt passages 1446 after undergoing fission reactions therein and generating heat. The emission sections 1504a, 1504b may emit a flow of inert gas toward the elevated temperature flow 1599a of the molten salt, and generally toward a centerline of the reactor 1442. The inert gas emitted therefrom may mix generally with the molten salt and cause the elevated flow 1599a to increase in buoyancy. The molten salt and inert gas may generally travel elevationally upward such that an increased buoyancy salt flow 1599b reaches the heat exchanger 1462.

FIG. 16 depicts a flow diagram of a method 1600 of operating an integral molten salt reactor. At operation 1604, fission reactions are caused in a fuel salt in a critical region of an integrally constructed reactor vessel. For example, and with reference to FIGS. 1 and 12, a fuel salt 102 is circulated with the critical region 108 of the MSR vessel 104. For example, the fuel salt 102 may undergo fission reactions within the a reactor core 142. Said fission reactions may cause the fuel salt 102 to increase in temperature.

At operation 1608, fuel salt is circulated through a fuel salt circuit of the critical region and heat is removed therefrom. For example, and with reference to FIGS. 1 and 12, the fuel salt 102 may be routed along a fuel salt circuit from the reactor core 142 to one or more heat exchangers 162 of the MSR system 100. For example, natural convection may assist the fuel salt 102 from moving from an exit of the reactor core 142 to the one or more heat exchangers 162. The one or more heat exchanger 162 may operate to extract heat from the fuel salt 102, thereby reducing the temperature of the fuel salt.

At operation 1612, inert gas bubbles are injected into an elevated temperature flow of the fuel salt in the fuel salt circuit to encourage flow therethrough. For example, and with reference to FIGS. 1 and 12, the bubbler 200 may be configured to emit a flow of inert gas into the molten salt. The bubbler 200 may emit a flow of inert gas into an elevated temperature of flow of the flow salt at an exit of the reactor core 142. In this regard, the bubbler may operate to increase a buoyancy of the molten salt. The increased buoyancy of the molten salt flow may support natural convection of the molten salt in the system 100.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An integral molten salt reactor comprising
a subcritical region defining a subcritical volume for the storage of the fuel salt away from a reactor core; and
a critical region defining a critical volume for fission reactions and for circulation of a fuel salt through a fuel salt circuit of the critical volume,
wherein the critical region is configured to promote the circulation of fuel salt by injecting inert gas bubbles into an elevated temperature flow of the fuel salt in the fuel salt circuit.

2. The integral molten salt reactor of claim 1, wherein the critical region includes a bubbler configured to inject the inert gas bubbles proximal to an exit of a reactor core of the critical region, the reactor core configured to cause the fission reactions.

3. The integral molten salt reactor of claim 2, wherein the bubbler is configured to inject the inert gas bubbles along an injection flow path toward a heat exchanger of the critical region, the heat exchanger disposed elevationally above the reactor core.

4. The integral molten salt reactor of claim 1, wherein the bubbler is operable to generate inert gas bubbles having a size and a shape configured to promote elevationally upward movement of said inert gas bubbles and of the fuel salt associated therewith.

5. The integral molten salt reactor of claim 1, wherein
the integral molten salt reactor further comprises an inert gas region defining an inert gas headspace along a boundary with the critical volume, and
the inert gas headspace is configured to receive the inert gas bubbles injected at the critical region.

6. The integral molten salt reactor of claim 5, further comprising a mesh configured to extinguish the inert gas bubbles along the boundary.

7. The integral molten salt reactor of claim 1, wherein the injected inert gas bubbles enhance the buoyancy of the fuel salt through the elevated temperature flow segment of the fuel salt circuit, thereby enhancing natural convection of the integral molten salt reactor therethrough.

8. A method of operating an integral molten salt reactor, the method comprising
causing fission reactions in a fuel salt in a critical region of an integrally constructed vessel; and
circulating the fuel salt through a fuel salt circuit of the critical region and removing heat therefrom,
wherein the circulating comprises injecting inert gas bubbles into an elevated temperature flow of the fuel salt in the fuel salt circuit to encourage flow of the fuel salt through the fuel salt circuit.

9. The method of claim 8, wherein the injecting of the inert gas bubbles comprises injecting the inert gas bubbles along an injection flow path toward a heat exchanger of the critical region, the heat exchanger disposed elevationally above a reactor core within which said fission reactions occur.

10. The method of claim 9, wherein the circulating further comprises increasing a buoyancy of the salt using the inert gas and causing the fuel salt to travel elevationally upward toward and into the heat exchanger.

11. The method of claim 10, further comprising popping the inert gas bubbles on entrance to an inert gas region of the integral molten salt reactor, the inert gas region defining a headspace along a boundary with a critical volume of the critical region.

12. The method of claim 8, further comprising, in response to a shutdown event, draining the fuel salt to a subcritical region of the integrally constructed vessel.

13. The method of claim 9, wherein the injection flow path defines a dedicated channel for the elevated temperature fuel salt that is separate from the lower temperature fuel salt, the lower temperature fuel salt being disposed along a periphery of the integrally constructed vessel.

14. The method of claim 8, wherein the injecting of the inert gas bubbles further comprising injecting said inert gas bubbles adjacent to or along a centerline of the integrally constructed vessel.

15. An integral molten salt reactor comprising
an integrally constructed vessel defining a critical region;
a reactor core disposed within the critical region;
a bubbler disposed at an exit of the reactor core;
a heat exchanger disposed elevationally above the reactor core, and
a fuel salt disposed throughout a fuel salt circuit including the reactor core and the heat exchanger,
wherein the integral molten salt reactor is configured to
heat the fuel salt via fission reactions caused within the reactor core,
circulate the fuel salt from the reactor core to the heat exchanger using an inert gas output from the bubbler, and
export heat from the fuel salt at heat exchanger.

16. The integral molten salt reactor of claim 15, wherein
the integrally constructed vessel further defines a subcritical region,
the integral molten salt reactor further comprises a drain tank disposed within the subcritical region, wherein the heat exchanger, the reactor core, and the drain tank are fully enclosed within the integrally constructed vessel, and
upon a shutdown event, the integral molten salt reactor is configured to cause the fuel salt to gravitationally transfer to the drain tank by altering a pressure differential between the critical region and the subcritical region.

17. The integral molten salt reactor of claim 16, further comprising a sealed containment structure defining a containment volume, wherein the integrally constructed vessel is fully disposed within the containment volume.

18. The integral molten salt reactor of claim 17, wherein the sealed containment structure surrounds a fission product adsorbing/absorbing material positioned within the containment volume and radially outside of the integrally constructed vessel.

19. The integral molten salt reactor of claim 15, wherein
the bubbler comprises an orifice having an orifice size and an orifice cross-section, and
the orifice size and the orifice cross-section are configured to produce inert gas bubbles of sufficient velocity to travel elevationally upward toward the heat exchanger.

20. The integral molten salt reactor of claim 15, wherein
the integral molten salt reactor further comprises a popping mesh arranged elevationally above the heat exchanger and adjacent a boundary of an inert gas headspace, and
the popping mesh is configured to receive the inert gas output and dissipate bubbles formed therewith as said bubbles enter the inert gas headspace.
